(19) United States
(12) Patent Application Publication
(10) Pub. No.: US 2010/0097377 A1
(43) Pub. Date: Apr. 22, 2010

(54) Graphics Processing Using Culling on Groups of Vertices

(76) Inventors: Jon Hasselgren, Bunkeflostrand (SE); Jacob Munkberg, Malmo (SE); Petrik Clarberg, Lund (SE); Tomas Akenine-Moller, Lund (SE); Ville Miettinen, Helsingfors (FI)

Correspondence Address: TROP, PRUNER & HU, P.C., 1616 S. VOSS RD., SUITE 750, HOUSTON, TX, 77057-2631, US

(21) Appl. No.: 12/581,339

(22) Filed: Oct. 19, 2009

Related U.S. Application Data
(60) Provisional application No. 61/106,766, filed on Oct. 20, 2008.

(51) Int. Cl. G06T 1/00; G06T 15/60

(52) U.S. Cl. 345/426; 345/522

(57) ABSTRACT

A first representation of a group of vertices may be received and a second representation of said group of vertices may be determined based on said first representation. A first set of instructions may be executed on said second representation of the group of vertices for providing a third representation of said group of vertices. The first set of instructions is associated with vertex position determination. The third representation of the group of vertices is subjected to a culling process.

### CROSS-REFERENCE TO RELATED APPLICATIONS

This application claims the benefit of Provisional Application Ser. No. 61/106,766, filed Oct. 20, 2008, which is incorporated by reference in its entirety.

### BACKGROUND

This relates generally to graphics processing and, particularly, to culling in graphics processing.

New applications and games use ever more realistic graphics processing techniques. As a result, there is always a benefit in increasing maintained frame rates, which are the rendered screen images per second, with higher scene complexities, higher geometry detail, higher resolution, and higher quality. Ideally, these improved characteristics are such that the screen image can be rendered as quickly as possible.

One way to increase performance is to increase the processing power of graphics processing units by enabling higher clock speeds, pipelining, or exploiting parallel computations. However, some of these techniques may result in higher power consumption and more generated heat. For battery operated devices, higher power consumption may reduce battery life. Power consumption and heat are major constraints for mobile devices and desktop display adapters. Moreover, there are limits to the clock speeds of any given graphics processing unit.

A primitive is a geometric shape, such as a triangle, quadrilateral, polygon, or any other geometry form. Alternatively, a primitive may be a surface or a point in space. A primitive that is represented as a triangle has three vertices and a quadrilateral has four vertices. Thus, a vertex comprises data associated with a location in space. For example, a vertex may comprise all data associated with the corner of a primitive. The vertices are associated not only with three spatial coordinates, but also with other graphical information to render objects correctly, including color, reflectance properties, textures, and surface normals.

Culling may be used to avoid unnecessary graphics processing. For example, image elements that are not going to be revealed in the final depiction may be culled early on in the processing to avoid performance loss inherent in processing elements that make no difference. Thus, culling may be used to remove details of the back face of a surface that will not show in the final depiction, to remove elements that are occluded by other elements, and in a variety of other circumstances, elements that are not material to the final depiction may be culled.

### BRIEF DESCRIPTION OF THE DRAWINGS

FIG. 1a is a schematic depiction of a vertex culling operation in accordance with one embodiment;

FIG. 1b is a schematic depiction of another embodiment of the present invention;

FIG. 1c is a schematic depiction of still another embodiment of the present invention;

FIG. 1d is a schematic depiction of still another embodiment of the present invention;

FIG. 1e is a schematic depiction of still another embodiment of the present invention;

FIG. 2a is a flow chart for the embodiment shown in FIGS. 1a-1e;

FIG. 2b is a flow chart for the embodiment shown in FIGS. 1a-1e;

FIG. 2c is a flow chart for the embodiment shown in FIGS. 1a-1e;

FIG. 2d is a flow chart for the embodiment shown in FIGS. 1a-1e;

FIG. 3 is a flow chart showing the vertex probing process that can be executed in the vertex probing units of FIGS. 1a-1e; and

FIG. 4 is a schematic depiction of a general purpose computer in accordance with one embodiment of the present invention.

### DETAILED DESCRIPTION

In accordance with some embodiments, culling may be performed on groups of vertices, as opposed to performing culling on individual vertices. Performing culling on groups of vertices may be advantageous, in some embodiments, because groups of vertices may be discarded, which may result in performance gains in some cases. Furthermore, a majority of surfaces of objects being rendered are invisible and the fully rendered images are not forwarded in the process, which results in performance gains. In other words, in some embodiments, performing culling on groups of vertices avoids rendering surfaces that are not visible in the current frame, achieving performance gains in some cases.

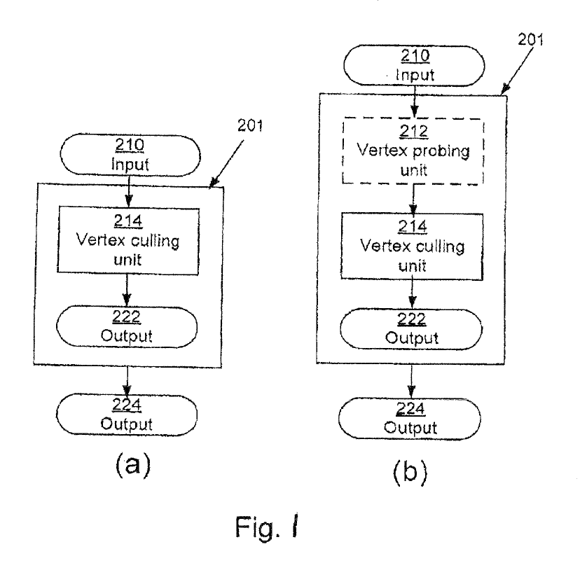

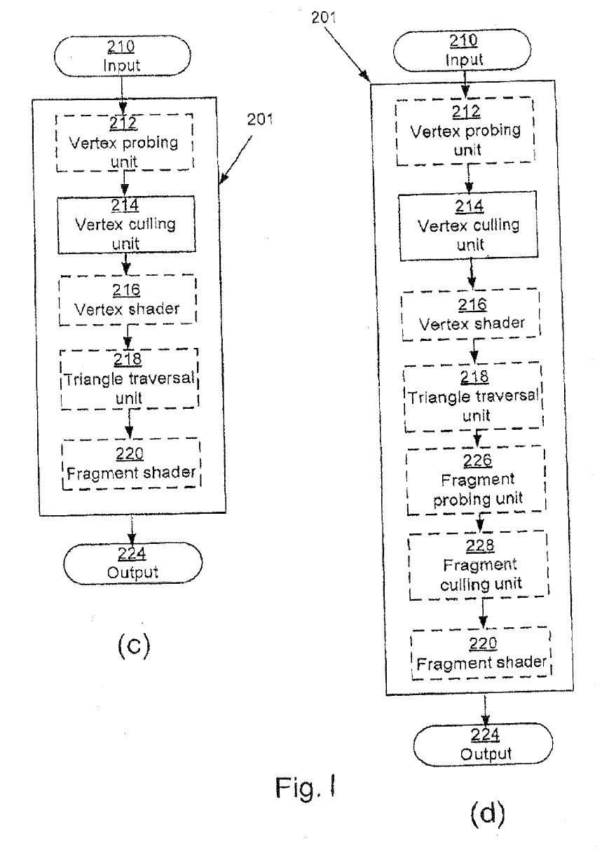

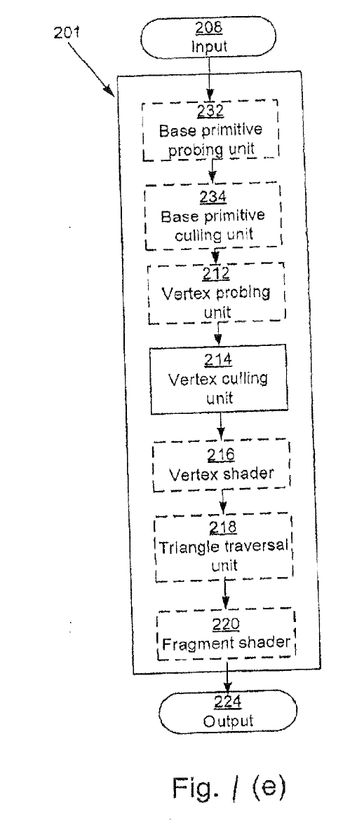

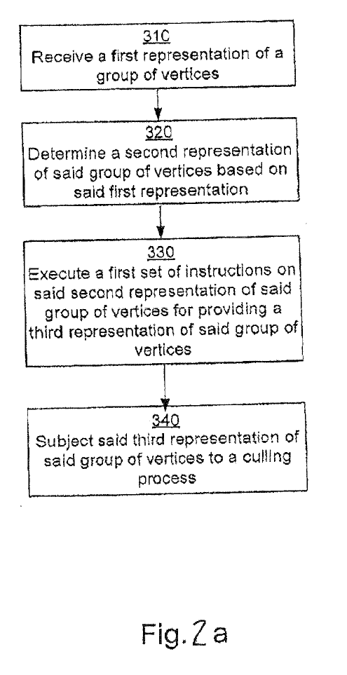

FIG. 1a is a block diagram illustrating an embodiment of a display adapter 201 according to one embodiment. The display adapter 201 comprises circuitry for generating digitally represented graphics, forming a vertex culling unit 214 for culling of groups of vertices.

The input 210 to the vertex culling unit 214 is a first representation of a group of vertices. A first representation of a group of vertices may be the vertices themselves.

In the vertex culling unit 214, culling is performed on groups of vertices and on representations of vertices. The output 222 from the vertex culling unit 214 may be that the group of vertices is to be discarded. The output 224 from the display adapter 201 may be displayed on a display.

The display adapter 201 can further comprise a vertex probing unit 212, shown in FIG. 1b. The vertex probing unit 212 is arranged to check whether at least one vertex of the group of vertices can be culled. The at least one vertex can be the first, last, and/or middle vertex in the group of vertices. Alternatively, it can be randomly selected from the group of vertices. The vertex probing unit 212 may use a vertex shader to transform the vertex. The vertex probing unit 212 then performs, for example, view frustum culling. The unit 212 determines whether the at least one vertex is inside the view frustum, and if it is, it cannot be culled. It is, however, to be noted that other culling techniques known to a person skilled in the art could be used as well.

If the at least one vertex of the group of vertices cannot be culled it implies that the entire group of vertices cannot be culled and then it is better not to perform the culling in the vertex culling unit 214 on the entire group of vertices since such culling consumes processing capacity.

FIG. 1c is a block diagram illustrating how different entities in a display adapter 201 may interact in one embodiment. The display adapter 201 comprises a vertex culling unit 214, a vertex shader 216, a triangle traversal unit 218, and a fragment shader 220.

In one embodiment, the display adapter 201 of FIG. 1c can also comprise a vertex probing unit 212, which has been previously described in connection with FIG. 1b.

In yet another embodiment, shown in FIG. 1d, the display adapter 201 comprises a vertex culling unit 214, a vertex shader 216, a triangle traversal unit 218, a fragment culling unit 228, and a fragment shader 220. In one embodiment, the display adapter 201 of FIG. 1d can also comprise a vertex probing unit 212.

In the fragment culling unit 228, culling is performed on tiles according to a replaceable culling program, also known as a replaceable culling module. The details of this culling program and the effects are explained in more detail in U.S. patent application Ser. No. 12/523,894, filed Jul. 21, 2009, the content of which is hereby incorporated by reference.

The embodiment of FIG. 1d can also comprise a fragment probing unit 226. The fragment probing unit 226 is arranged to check whether at least one pixel from a tile can be culled. The at least one pixel can, for example, be the center pixel of the tile or the four corners of the tile. If the at least one pixel of the tile cannot be culled, it implies that the tile cannot be culled and then it is better not to perform the culling in the fragment culling unit 228 since the culling may waste capacity.

In yet another embodiment, shown in FIG. 1e, the display adapter 201 comprises a base primitive culling unit 234, a vertex culling unit 214, a vertex shader 216, a triangle traversal unit 218, and a fragment shader 220.

The vertex culling unit 214 and the output 224 from the display adapter 201 have been previously described in connection with FIG. 1a. The input 208 to the base primitive culling unit 234 is a base primitive. A geometric primitive in the field of computer graphics is usually interpreted as an atomic geometric object that the system can handle, for example, with a draw or store. Atomic geometric objects may be interpreted as geometric objects that cannot be divided into smaller objects. All other graphics elements are built up from these primitives.

In one embodiment, the display adapter 201 of FIG. 1e, can also comprise a vertex probing unit 212, which has been previously described in connection with FIG. 1b. In the base primitive culling unit 234, culling is performed on base primitives according to a culling program.

The embodiment of FIG. 1e can also comprise a base primitive probing unit 232. The base primitive probing unit 232 is arranged to check whether at least one vertex of a base primitive can be culled. At least one vertex from the base primitive is selected. The at least one vertex can, for example, be the vertices of the base primitive or the center of the base primitive. If the at least one vertex of the base primitive cannot be culled, the base primitive cannot be culled and then it is better not to perform the base primitive culling in the base primitive culling unit 234 since base primitive culling wastes capacity.

In yet another embodiment, not shown in the figures, the display adapter 201 can comprise a base primitive probing unit 232, a base primitive culling unit 234, a vertex probing unit 212, a vertex culling unit 214, a vertex shader 216, a triangle traversal unit 218, a fragment probing unit 226, a fragment culling unit 228, and a fragment shader 220.

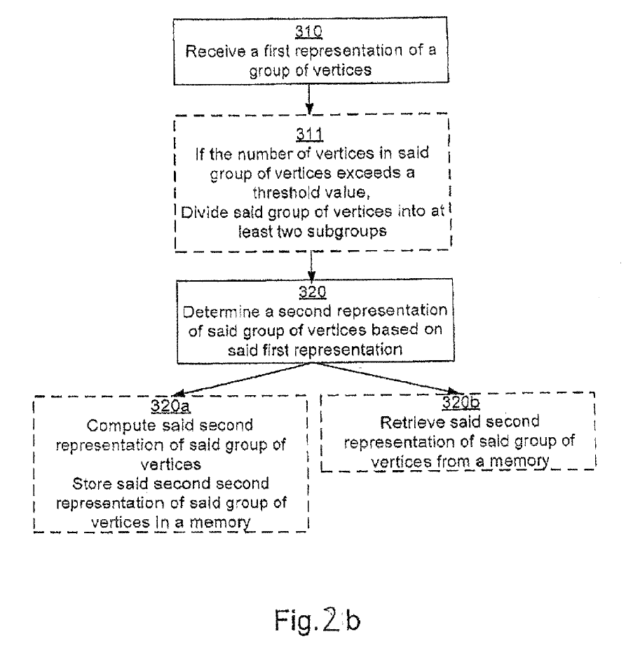

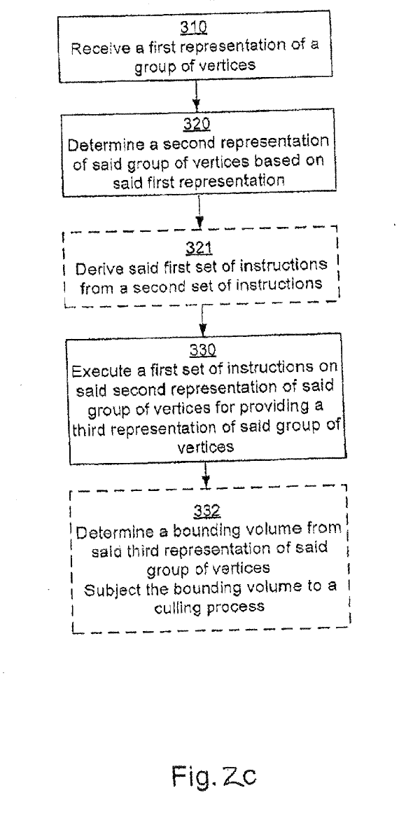

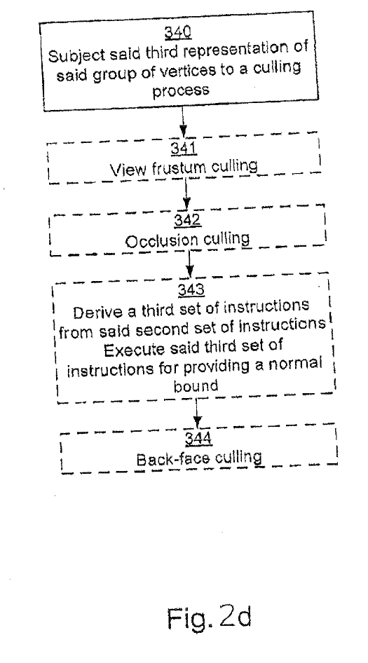

FIG. 2a shows a flow chart for a culling program that can be executed on a group of vertices in the vertex culling unit 214 of FIGS. 1a, 1b, 1c, 1d, and 1e. In step 310, a first representation of a group of vertices is received. The received group of vertices may comprise vertices from at least two primitives. The vertices to be input into the vertex shader 216 are gathered into groups using so called draw calls. A draw call comprises vertices and information about how the vertices are connected to create primitives, such as triangles.

The vertices in a draw call share a common rendering state, which implies that they are associated with the same vertex shader, and also with the same geometry shader, pixel shader and also other types of shaders. A rendering state describes how a particular type of object is rendered, including its material properties, associated shaders, textures, transform matrices, lights, etc. A rendering state could, for example, be used for rendering all primitives of a part of a piece of wood, a part of a man, or the stem of a flower. All vertices in the same draw call can be used to render objects with the same material/appearance.

Usually many draw calls are needed in order to render an entire image. Draw calls are used because it is more efficient to render a relatively large set of primitives with the same states and shaders than to render one primitive at a time and having to switch shader programs for each primitive. Another advantage with using draw calls is that overhead is avoided in the Application Programming Interface (API) and in the graphics hardware architecture.

In step 320, a second representation of said group of vertices is determined based on said first group of vertices. The second representation of the group of vertices can be computed using bounded arithmetic. A three-dimensional model comprises k vertices, pⁱ, iε[0, k−1]. The bounds of the x coordinates can for example be computed as: \tilde{p}ₓ=└minᵢ(pₓⁱ),maxᵢ(pₓⁱ)┘, i.e the minimum and maximum of all x-coordinates of the vertices pⁱ, iε[0, k−1] are computed. This results in an interval: \tilde{p}ₓ=└pₓ, p̅ₓ̅. Such an interval can be computed for all other components of p and for all other varying parameters as well. It is to be noted that other types of computations can be applied instead in order to compute these bounds. In the example above, interval arithmetic is used. Affine arithmetic or Taylor arithmetic are examples of other types of bounded arithmetic that could be used instead.

In step 330, a first set of instructions is executed on the second representation of said group of vertices for providing a third representation of said group of vertices. When executing the first set of instructions, bounded arithmetic can be used. The bounded arithmetic can, for example, be Taylor arithmetic, interval arithmetic, or affine arithmetic, as a few examples.

In one embodiment, one or more polynomials are fitted to the attributes of the group of vertices and Taylor models are constructed, wherein the polynomial part comprises the coefficients of the fitted polynomials, and the remainder term is adjusted so that the Taylor model includes all vertices in the group. Such an approach may give sharper bounds than when using interval arithmetic, in some cases.

In step 340, said third representation of said group of vertices is subjected to a culling process. Culling is performed in order to avoid drawing objects, or part of objects, that are not seen.

FIGS. 2b-d show flow charts for different embodiments of a culling program according to FIG. 2a, that can be executed on a group of vertices in the vertex culling unit 214 of FIGS. 1a, 1b, 1c, 1d, and 1e. The groups of vertices received in step 310 can be gathered in different ways. One way is to use the entire draw call which implies that the first representation of the group of vertices comprises all vertices in the draw call. Another way is to gather the vertices of m primitives, where m is a constant. When using this alternative, the first representation of the group of vertices can span more than one draw call. Another way is to gather the vertices according to step 311, as indicated in FIG. 2b. If the number of vertices in the group of vertices exceeds a threshold value, the group of vertices is divided into at least two subgroups, wherein the at least two subgroups comprise vertices that are associated with the same set of instructions associated with vertex position determination. This way of gathering vertices may be a combination of the two previously described ways in one embodiment. Using this way, a group may not span across more than one draw call and the size of the group may not be bigger than m. Another way to gather the vertices comprises computing intervals enclosing, for example, the positions of the vertices. The intervals can be computed for other parameters as well, such as, for example, color. Vertices are added to the group until the intervals exceed a predetermined threshold.

In one embodiment, in step 320, the second representation of the group of vertices can be computed and then stored in a memory, in step 320a (FIG. 2b). The next time the second representation of the group of vertices is needed, it can be retrieved from the memory. This is capacity efficient since the computation does not have to be performed for every group of vertices. This solution is possible as long as the groups of vertices that are input are associated with the same set of instructions associated with vertex position determination and with the same vertex attributes. Vertex attributes can, for example, be vertex positions, normals, texture coordinates, etc.

In another embodiment, in step 320, the second representation of the group of vertices can be retrieved from a memory in step 320b (FIG. 2b).

In one embodiment, the first set of instructions can be derived from a second set of instructions associated with vertex position determination (step 321 in FIG. 2c). The second set of instructions associated with vertex position determination is herein to be interpreted as the instructions in a vertex shader.

The set of instructions is then analyzed and all instructions that are used to compute the vertex position are isolated. The instructions are redefined into operating on bounded arithmetic, for example, Taylor arithmetic, interval arithmetic, affine arithmetic, or another suitable arithmetic.

Assume that a vertex in homogeneous coordinates is denoted, P=(pₓ, p_{y}, p_{z}, p_{w})^{T} (where p_{w}=1, usually), and ^{T} is the transpose operator, i.e., column vectors are used. In the simplest form, a vertex shader program is a function that operates on a vertex, p, and computes a new position P_{d}. More generally, the vertex shader program is a function that operates on a vertex, p, and on a set of varying parameters, tᵢ, iε[0, n−1], see equation (1).

P=f(p,t,M) equation (1)

To simplify notation, all the tᵢ parameters are put into a long vector, t. The parameters can, for example, be time, texture coordinates, normal vectors, textures, and more. The parameter, M, represents a collection of constant parameters, such as matrices, physical constants, and so on.

The vertex shader program may have many other outputs besides P_{d}, and therefore more inputs as well. In the following, it is assumed that the arguments (parameters) to f are used in the computation of P_{d}.

When deriving the first set of instructions associated with vertex position determination, the vertex shader is reformulated so that the input is said second representation (for example, interval bounds for the attributes of the group of vertices) and the output is bounds for the vertex positions, see equation (2).

\tilde{P}_{d}=ƒ(\tilde{P},\tilde{t},M) equation (2)

A brief description of Taylor models follows in order to facilitate the understanding of the following steps. Intervals are used in Taylor models, and the following notation is used for an interval:

â=[a,ā]={x|a≦x≦ā} equation (3)

Given an n+1 times differentiable function, f(u), where uε[u₀,u₁], the Taylor model of f is composed of a Taylor polynomial, T_{f}, and an interval remainder term, \hat{r}ƒ. An nth order Taylor model, here denoted \tilde{ƒ}, over the domain uε[u₀,u₁] is then:

$$\tilde{f} ( u ) ∈ {\sum }_{k = 0}^{n} \frac{{f}^{( k )} ( {u}_{0} )}{k !} \cdot {( u - {u}_{0} )}^{k} + [ \underline{{r}_{f}} , \overline{{r}_{f}} ] = {\sum }_{k = 0}^{n} {c}_{k} {u}^{k} + {\hat{r}}_{f} , \qquad equation ( 4 )$$

wherein

$${\sum }_{k = 0}^{n} \frac{{f}^{( k )} ( {u}_{0} )}{k !} \cdot {( u - {u}_{0} )}^{k}$$

is the Taylor polynomial and └r_{ƒ}, r̅_̅{̅ƒ̅}̅┘ is the interval remainder term. This representation is called a Taylor model, and is a conservative enclosure of the function f over the domain uε[u₀>u₁]. It is also possible to define arithmetic operations on Taylor models, where the result is a conservative enclosure as well (another Taylor model). As a simple example, assume that f+g is to be computed, and that these functions are represented as Taylor models, \tilde{ƒ}=(T_{ƒ},\tilde{r}_{ƒ}) and \tilde{g}=(T_{g},\tilde{r}_{g}). The Taylor model of the sum is then (T_{ƒ}+T_{g},\hat{r}_{ƒ}+\hat{r}_{g}). More complex operations like multiplication, sine, log, exp, reciprocal, etc. can also be derived. Implementation details for these operators are described in BERZ, M., AND HOFFSTÄTTER, G. 1998, Computation and Application of Taylor Polynomials with Interval Remainder Bounds, Reliable Computing, 4, 1, 83-97.

In one embodiment, the second representation of the group of vertices can be interval bounds for the vertex attributes, for example, position and/or normal bounds. The first set of instructions may be executed using bounded arithmetic. In this embodiment, the third representation is a bounding volume. In one embodiment, the bounding volume may be a bounding box. The third representation is, for example, determined by computing the minimum and maximum values for every vertex attribute. In one embodiment, a bounding volume enclosing said third representation of said group of vertices is determined and said bounding volume is subject to a culling process, step 332 of FIG. 2c.

A bounding volume for a set of objects is a closed volume that completely comprises the union of the objects in the set. Bounding volumes may be of various shapes, for example, boxes such as cuboids or rectangles, spheres, cylinders, polytopes, and convex hulls.

The bounding volume may be a tight bounding volume in one embodiment. The bounding volume being tight implies that the area or volume of the bounding volume is as small as possible but still completely encloses the third representation of the group of vertices.

In one embodiment, the second representation of the group of vertices is a Taylor model of the vertex attributes. The first set of instructions is executed using Taylor arithmetic. The third representation of a group of vertices may be bounds that are computed from the second representation using the first set of instructions. These bounds may be computed for example according to what is disclosed in “Interval Approximation of Higher Order to the Ranges of Functions,” Qun Lin and J. G. Rokne, Computers Math. Applic., vol 31, no. 7, pp. 101-109, 1996. In one embodiment, a bounding volume enclosing said third representation of said group of vertices is determined and the bounding volume is subject to a culling process.

In another embodiment, the first representation of the group of vertices can describe a parameterized surface (for example, an already tessellated surface) that is parameterized by two coordinates, for example (u,v). In another embodiment, one or more polynomial models have been fitted to the attributes of the group of vertices.

In one embodiment, the third representation may be a Taylor model and can be a polynomial approximation of the vertex position attribute. More specifically, it may be positional bounds: \tilde{p}(u,v)=(\tilde{p}ₓ,\tilde{p}_{y}, \tilde{p}_{z}, \tilde{p}_{w}), that is four Taylor models. For a single component, for example x, this can be expressed in the power basis as follows (the remainder term, \hat{r}_{ƒ}, has been omitted for clarity):

$${P}_{x} ( u , v ) = {\sum }_{i + j \leq n} {a}_{- ij} {u}^{i} {v}^{j} \qquad equation ( 5 )$$

In one embodiment, the third representation of said group of vertices may be normal bounds. For a parameterized surface, the unnormalized normal, n, can be computed as:

$$n ( u , v ) = \frac{\partial p ( u , v )}{\partial u} \times \frac{\partial p ( u , v )}{\partial v} \qquad equation ( 6 )$$

The normal bounds, that is the Taylor model of the normal, is then computed as:

$$\tilde{n} ( u , v ) = \frac{\partial \tilde{p} ( u , v )}{\partial u} \times \frac{\partial \tilde{p} ( u , v )}{\partial v} \qquad equation ( 7 )$$

The third representation of the group of vertices may be Taylor polynomials on power form. One way of determining the bounding volume may be by computing the derivatives of the Taylor polynomials and thus finding the minimum and maximum of the third representation. Another way to determine the bounding volume may be according to the following. The Taylor polynomials are converted into Bernstein form. Due to the fact that the convex hull property of the Bernstein basis guarantees that the actual surface or curve of the polynomial lies inside the convex hull of the control points obtained in the Bernstein basis, the bounding volume is computed by finding the minimum and maximum control point value in each dimension. Transforming equation 5 into Bernstein basis gives:

$$p ( u , v ) = {\sum }_{i + j \leq n} {P}_{ij} {B}_{ij}^{n} ( u , v ) \qquad equation ( 8 )$$

where

$${B}_{ij}^{n} ( u , v ) = ( \begin{matrix}\begin{matrix}n \\ \end{matrix} \\ i\end{matrix} ) ( \begin{matrix}\begin{matrix}n - i \\ \end{matrix} \\ j\end{matrix} ) {u}^{i} {{v}^{j} ( 1 - u - v )}^{n - i - j}$$

are the Bernstein polynomials in the bivariate case over a triangular domain. This conversion is performed using the following formula, the formula being described in HUNGERBüHLER, R., AND GARLOFF, J. 1998, Bounds for the Range of a Bivariate Polynomial over a Triangle. Reliable Computing, 4, 1, 3-13:

$${P}_{ij} = {\sum }_{l = 0}^{i} {\sum }_{m = 0}^{j} \frac{( \begin{matrix}\begin{matrix}i \\ \end{matrix} \\ l\end{matrix} ) ( \begin{matrix}\begin{matrix}j \\ \end{matrix} \\ m\end{matrix} )}{( \begin{matrix}\begin{matrix}n \\ \end{matrix} \\ l\end{matrix} ) ( \begin{matrix}\begin{matrix}n - 1 \\ \end{matrix} \\ m\end{matrix} )} {a}_{l m} \qquad equation ( 9 )$$

To compute a bounding box, simply the minimum and maximum values over all pᵢⱼ for each dimension, x, y, z, and w are computed. This gives a bounding box, \hat{b}=(\hat{b}ₓ,\hat{b}_{y},\hat{b}_{z},\hat{b}_{w}), where each element is an interval, for example \hat{b}ₓ=[bₓ, b̅ₓ̅].

In this approach, the positional bounds, normal bounds, and bounding volume derived above are used for applying different culling techniques on the groups of vertices.

In one embodiment, view frustum culling is performed using the positional bound or said bounding volume, step 341 in FIG. 2d. In one embodiment, occlusion culling is performed using said positional bound or said bounding volume, step 342 in FIG. 2d. In one embodiment, a third set of instructions is derived from said second set of instructions and said third set of instructions is executed for providing a normal bound, step 343 in FIG. 2d. In one embodiment, back-face culling is performed using at least one from the group of said normal bound, said positional bound, and said bounding volume, step 344 in FIG. 2d. In one embodiment, at least one of the steps 341, 342, and 344 is performed. The steps 341-344 do not have to be performed in the exact order disclosed.

The culling techniques disclosed herein are not to be construed as limiting, but they are provided by way of example. A person skilled in the art would realize that back-face culling, occlusion culling, and view frustum culling may be performed using various techniques different than the ones described herein.

View frustum culling is a culling technique based on the fact that only objects that will be visible, that is, that are located inside the current view frustum, are to be drawn. The view frustum may be defined as the region of space in the modeled world that may appear on the screen. Drawing objects outside the frustum would be a waste of time and resources since they are not visible anyway. If an object is entirely outside the view frustum, it cannot be visible and can be discarded.

In one embodiment, the positional bounds of the bounding volume are tested against the planes of the view frustum. Since the bounding volume, \hat{b}, is in homogeneous clip space, the test may be performed in clip space. A standard optimization for plane-box tests may be used, where only a single corner of the bounding volume, the bounding volume being a bounding box, is used to evaluate the plane equation. Each plane test then amounts to an addition and a comparison. For example, testing if the volume is outside the left plane is performed using: b̅ₓ̅+ b̅_̅{̅w̅}̅<0. The testing may also be performed using the positional bounds, \tilde{p}(u,v)=(\tilde{p}ₓ,\tilde{p}_{y},\tilde{p}_{z},\tilde{p}_{w}). Since these tests are time and resource efficient, it may be advantageous, in some embodiments, to let the view frustum test be the first test.

Back-face culling discards objects that are facing away from the viewer, that is, the all normal vectors of the object are directed away from the viewer. These objects will not be visible and there is, hence, no need to draw them.

Given a point, p(u,v) on a surface, back-face culling is in general computed as:

c=p(u,v)·n(u,v) equation (10)

where n(u,v) is the normal vector at (u, v). If c>0, then p(u,v) is back-facing for that particular value of (u,v). As such, this formula can also be used to cull, for example, a triangle or a group of triangles, such as triangles described by a group of vertices. The Taylor model of the dot product (see equations 7 and 10) is computed: \tilde{c}=\tilde{p}(u,v)·ñ(u,v). To be able to back-face cull, the following must hold over the entire triangle domain: \tilde{c}>0. The lower bound on \tilde{c} is conservatively estimated again using the convex hull property of the Bernstein form. This gives an interval, \tilde{c}=[c, c̅], and the triangle or group of triangles can be culled if c̅>0.

In another embodiment, interval bounds are computed for the normals, for checking if the back-face condition is fulfilled.

The testing may also be performed using the positional bounds, \tilde{p}(u,v)=(\tilde{p}ₓ,\tilde{p}_{y},\tilde{p}_{z},\tilde{p}\tilde{p_{w}}) or alternatively, the bounding volume.

Occlusion culling implies that objects that are occluded are discarded. In the following, occlusion culling is described for a bounding box, but it is possible to perform occlusion culling on other types of bounding volumes as well.

The occlusion culling technique is very similar to hierarchical depth buffering, except that only a single extra level is used (8×8 pixel tiles) in the depth buffer. The maximum depth value, Zₘₐₓ^{tile}, is stored in each tile. This is a standard technique in graphics processing when rasterizing triangles. The clip-space bounding box, b, is projected and all tiles overlapping this axis-aligned box are visited. At each tile, the classic occlusion culling test is performed: Zₘᵢₙ^{box}≦Zₘₐₓ^{tile}, which indicates that the box is occluded at the current tile if the comparison is fulfilled. The minimum depth of the box, Zₘᵢₙ^{box}, is obtained from the clip-space bounding box, and the maximum depth of the tile, Zₘₐₓ^{tile}, from the hierarchical depth buffer (which already exists in a contemporary graphics processing unit. Note that the testing can be terminated as soon as a tile is found to be non-occluded, and that it is straightforward to add more levels to the hierarchical depth buffer. The occlusion culling test can be seen as a very inexpensive pre-rasterization of the bounding box of the group of primitives to be rendered. Since it operates on a tile basis, it is less expensive than an occlusion query.

In another embodiment, the testing may also be performed using the positional bounds, \tilde{p}(u,v)=(\tilde{p}ₓ,\tilde{p}_{y},\tilde{p}_{z},\tilde{p}\tilde{p_{w}}).

In one embodiment, the culling process is replaceable. This implies that the vertex culling unit 214 may be supplied with a user-defined culling process.

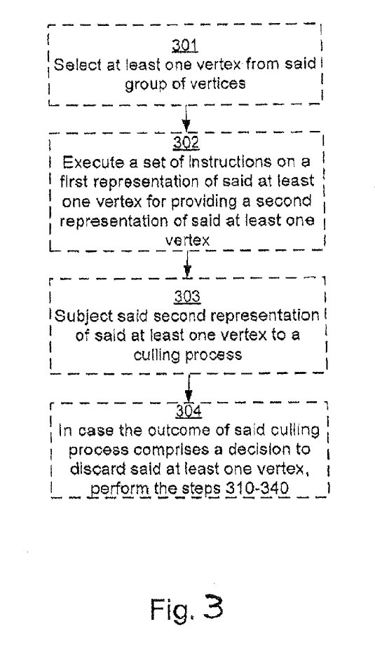

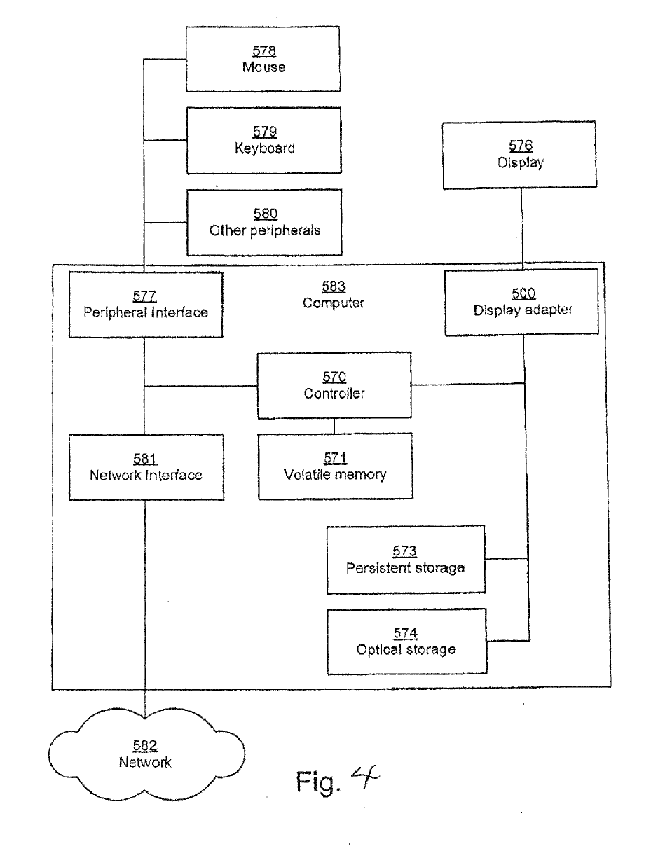

FIG. 3 shows a flow chart for a probing program that can be executed on at least one vertex in the vertex probing unit 212 of FIGS. 1a, 1b, 1c, 1d, and 1e.

At least one vertex is selected from the group of vertices in step 301. A set of instructions associated with vertex position determination are executed on a first representation of said at least one vertex for providing a second representation of said at least one vertex in step 302. The second representation of said at least one vertex is subject to a culling process, step 303, wherein an outcome of said culling process comprises one of a decision to discard said at least one vertex, and a decision not to discard said at least one vertex. In case the outcome of said culling process comprises a decision to discard said at least one vertex, the steps 310-340 are performed. The steps described in connection with FIGS. 2a-d can be performed in the apparatus 201 of the invention or embodiments of the invention.

FIG. 4 shows an overview architecture of a typical general purpose computer 583 embodying the display adapter 201 of FIG. 1. The computer 583 has a controller 570, such as a central processing unit, capable of executing software instructions. The controller 570 is connected to a volatile memory 571, such as a random access memory (RAM) and a display adapter 500, the display adapter corresponding to the display adapter 201 of FIG. 1. The display adapter 500 is in turn connected to a display 576, such as a monitor, a liquid crystal display (LCD) monitor, etc. The controller 570 is also connected to persistent storage 573, such as a hard drive or flash memory and optical storage 574, such as reader and/or writer of optical media such as CD, DVD, HD-DVD or Blue-ray. A network interface 581 is also connected to the controller 570 for providing access to a network 582, such as a local area network, a wide area network (e.g. the Internet), a wireless local area network or wireless metropolitan area network. Through a peripheral interface 577, e.g. interface of type universal serial bus, wireless universal serial bus, firewire, RS232 serial, PS/2, the controller 570 can communicate with a mouse 578, a keyboard 579 or any other peripheral 580, including a joystick, a printer, a scanner, etc.

In some embodiments, the sequences shown in FIGS. 2a-2d and 3 may be implemented in hardware, software, or firmware. In software or firmware implemented embodiments, computer executable instructions may be stored in a computer readable medium such as a semiconductor, optical, or magnetic storage medium. Suitable storage mediums for this purpose include any of the display adapter 500, controller 570, peripheral interface 577, volatile memory 571, persistent storage 573, or optical storage 574, as examples. Those instructions may be implemented by any processor, controller, or computer, including, but not limited to, the display adapter 500, controller 570, or peripheral interface 577, to mention a few examples.

It is to be noted that although a general purpose computer is described above to embody various embodiments of the invention, the invention can equally well be embodied in any environment where digital graphics, and in particular 3D graphics, is utilized, e.g. game consoles, mobile phones, MP3 players, etc.

Embodiments may furthermore be embodied in a much more general purpose architecture. The architecture may, for example, comprise many small processor cores that can execute any type of program. This implies a kind of a software graphics processor, in contrast to more hardware-centric graphics processing units.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a first representation of a group of vertices;
determining a second representation of said group of vertices based on said first representation;
executing a first set of instructions on said second representation of said group of vertices for providing a third representation of said group of vertices, said first set of instructions being associated with a vertex position determination; and
subjecting said third representation of said group of vertices to a culling process.

2. The method according to claim 1 wherein said executing a first set of instructions comprises using bounded arithmetic, wherein bounded arithmetic is at least one from the group of Taylor arithmetic, interval arithmetic, and affine arithmetic.

3. The method according to claim 1 wherein said determining a second representation further comprises using bounded arithmetic.

4. The method according to claim 3 wherein said bounded arithmetic is at least one from the group of Taylor arithmetic, interval arithmetic, and affine arithmetic.

5. The method according to claim 1 wherein said group of vertices comprises vertices from at least two primitives.

6. The method according to claim 1 wherein said group of vertices comprises vertices that are associated with the same set of instructions associated with vertex position determination.

7. The method according to claim 1 further comprising deriving said first set of instructions from a second set of instructions associated with vertex position determination.

8. The method according to claim 7 further comprising:
deriving a third set of instructions from said second set of instructions, and
executing said third set of instructions for providing a normal bound.

9. The method according to claim 1 wherein said receiving of a first representation further comprises:
if the number of vertices in said group of vertices exceeds a threshold value,
dividing said group of vertices into at least two subgroups,
wherein said at least two subgroups comprise vertices that are associated with the same set of instructions associated with vertex position determination.

10. The method according to claim 1 wherein said determining a second representation further comprises:
computing said second representation of said group of vertices; and
storing said second representation of said group of vertices in a memory.

11. The method according to claim 1 wherein said determining a second representation further comprises:
retrieving said second representation of said group of vertices from a memory.

12. The method according to claim 1 further comprising:
selecting at least one vertex from said group of vertices;
executing a set of instructions associated with vertex position determination on a first representation of said at least one vertex for providing a second representation of said at least one vertex; and
subjecting said second representation of said at least one vertex to a culling process, wherein an outcome of said culling process comprises one of
a decision to cull said at least one vertex;
a decision not to cull said at least one vertex; and
in case the outcome of said culling process comprises a decision to cull said at least one vertex, perform
said receiving a first representation of a group of vertices;
said determining a second representation of said group of vertices;
said executing a set of instructions associated with vertex position determination on said second representation of said group of vertices for providing a third representation of said group of vertices; and
said subjecting said third representation of said group of vertices to a culling process.

13. The method according to claim 1 further comprising:
determining a bounding volume enclosing said third representation of said group of vertices; and
subjecting said bounding volume to a culling process.

14. The method according to claim 13 wherein subjecting said bounding volume to said culling process further comprises performing at least one of:
subjecting said bounding volume to view frustum culling;
subjecting said bounding volume to back-face culling; and
subjecting said bounding volume to occlusion culling.

15. The method according to claim 1 wherein said third representation is at least one from the group of a positional bound, and a normal bound.

16. The method according to claim 15 wherein subjecting said third representation to said culling process further comprises performing at least one of:
subjecting said positional bound to view frustum culling;
subjecting said positional bound or said normal bound to back-face culling; and
subjecting said positional bound to occlusion culling.

17. An apparatus comprising:
a vertex culling unit to receive a first representation of a group of vertices, determine a second representation of said group of vertices, execute a first set of instructions associated with vertex position determination on said second representation of said group of vertices for providing a third representation of said group of vertices, and subject said third representation of said group of vertices to a culling process; and
a vertex shader coupled to said unit.

18. The apparatus of claim 17 including a vertex probing unit coupled to said vertex culling unit, said vertex probing unit to determine if at least one vertex of a group of vertices can be culled.

19. The apparatus of claim 17 including a triangle traversal unit and fragment shader coupled to said vertex shader.

20. The apparatus of claim 17 including a base primitive probing unit to check whether at least one vertex of a base primitive can be culled.

21. The apparatus of claim 20 including a base primitive culling unit to perform culling on base primitives.

22. The apparatus of claim 17 wherein said vertex culling unit to use bounded arithmetic to execute the first set of instructions.

23. The apparatus of claim 17 wherein said vertex culling unit to use bounded arithmetic for determining said second representation.

24. The apparatus of claim 22 wherein said bounded arithmetic is at least one of Taylor arithmetic, interval arithmetic, or affine arithmetic.

25. The apparatus of claim 21 wherein said group of vertices comprises vertices from at least two primitives.

26. A computer executable storage medium storing instructions to enable a computer to:
receive a first representation of a group of vertices;
determine a second representation of said group of vertices based on said first representation;
execute a first set of instructions on said first representation of said group of vertices to provide a third representation of said group of vertices, said first set of instructions being associated with a vertex position determination; and
subject said third representation of said group of vertices to a culling process.

27. The medium of claim 26 further storing instructions to determine whether said group of vertices comprises the vertices that are associated with the same set of instructions associated with the vertex position determination.

28. The medium of claim 26 further storing instructions to derive the first set of instructions from a set of instructions associated with the vertex position determination.

29. The medium of claim 28 further storing instructions to derive a third set of instructions from said second set of instructions and execute the third set of instructions to provide a normal bound.

30. The medium of claim 26 further storing instructions to determine if the number of vertices in said group of vertices exceeds a threshold and, if so, to divide the group of vertices into at least two subgroups, wherein said at least two subgroups comprise vertices that are associated with the same set of instructions associated with the vertex position determination.
